(19) United States
(12) Patent Application Publication
(10) Pub. No.: US 2024/0223768 A1
(43) Pub. Date: Jul. 4, 2024

(54) CONTENT ADAPTIVE CONFIGURABLE HIERARCHICAL AND PARTITIONAL MOTION ESTIMATION SEARCH

(71) Applicant: ATI TECHNOLOGIES ULC, MARKHAM (CA)

(72) Inventors: Yuxin Chen, Markham (CA); Ying Luo, Richmond Hill (CA); Edward Harold, Markham (CA); Shu-Hsien Wu, Aurora (CA); Xinghai Li, North York (CA); Razvan F. Dan-Dobre, Markham (CA); Min Wang, Mississauga (CA); Jianbin Xiao, Markham (CA); Amal Khailtash, Markham (CA); Yin Xia Yang, Markham (CA); Kai Sun, Markham (CA)

(21) Appl. No.: 18/089,928

(22) Filed: Dec. 28, 2022

(51) Int. Cl. H04N 19/137; H04N 19/105; H04N 19/176; H04N 19/53

(52) U.S. Cl. CPC H04N 19/137; H04N 19/105; H04N 19/176; H04N 19/53

(57) ABSTRACT

The present disclosure provides techniques for implementing a hierarchical and partitional integer motion estimation search (IMES) architecture using a search engine that is configurable based on a content of a plurality of frames in a video sequence. For example, the techniques include identifying, based on the plurality of frames, one or more search parameters for the hierarchical and partitional motion estimation, where the one or more search parameters are based on a content indicative of motion features tracked across the video sequence. The hierarchical and partitional motion estimation, which includes at least one decimated motion estimation search followed by a full-pixel level search, is performed based on the one or more identified search parameters to determine an integer (or pixel-level) motion vector.

### BACKGROUND

For many applications, such as videoconferencing, video gaming, and video streaming, transmitting and storing video data require large amounts of bandwidth and memory capacity due to user demand for relatively high quality. Video compression and encoding techniques are sometimes employed to reduce the bandwidth necessary to transmit video and reduce the memory capacity required to store video. For many video compression and encoding techniques, motion estimation is employed to exploit the temporal redundancies within a video sequence, thereby reducing the bit rate of the encoded video sequence.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a video encoding system in accordance with various embodiments.

FIG. 2 is a diagram illustrating a hierarchical aspect of the integer motion estimation search (IMES) architecture in accordance with various embodiments.

FIG. 3 is a diagram illustrating a search flow of a hierarchical and partitional IMES architecture with a configurable search engine in accordance with various embodiments.

FIG. 4 is a diagram illustrating a full pixel search order for variable coding blocks in accordance with various embodiments.

FIG. 5 illustrates examples of downsampling for the decimated searches in accordance with various embodiments.

FIG. 6 is a flow diagram illustrating a method for determining search parameters for the configurable search engine in accordance with various embodiments.

FIG. 7 is a flow diagram illustrating a method for determining motion vectors in accordance with various embodiments.

FIG. 8 is a diagram illustrating the determination of motion vectors for encoding a video sequence in accordance with various embodiments.

### DETAILED DESCRIPTION

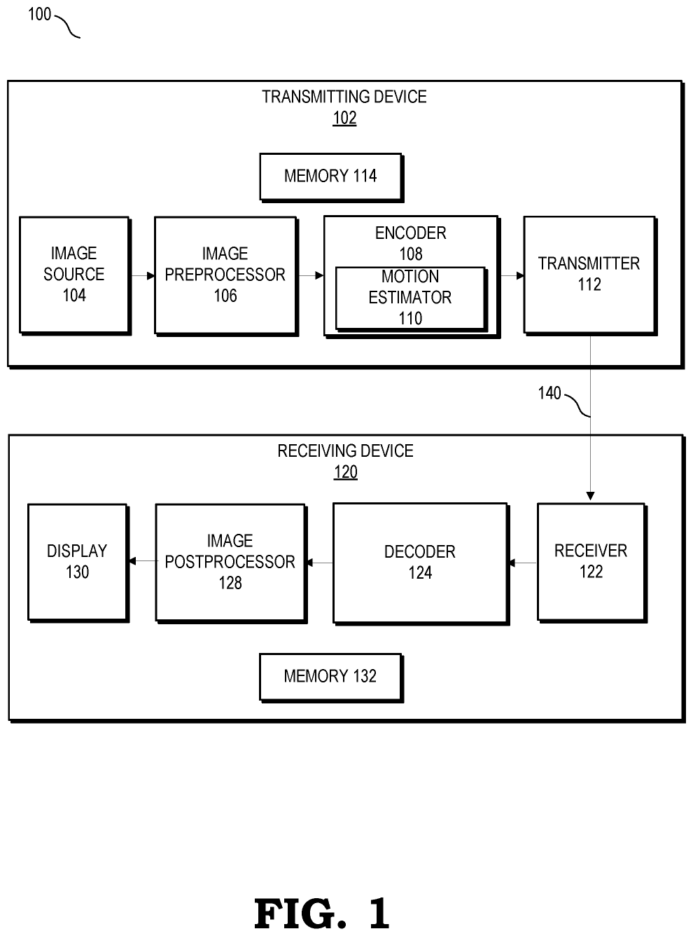

In video encoding, motion estimation is employed to determine a best match for pixels in a current frame relative to pixels in a reference frame within a search window applied to a sequence of frames. Based on the determined best match, motion vectors are computed that describe the transformation of the pixels from the reference frame to the current frame. This allows for a reference frame and a corresponding set of motion vectors to be used to represent a set of frames in an encoded video sequence instead of encoding the entire set of frames, thereby reducing the size of data needed to transmit and store the video sequence. However, motion estimation techniques that describe the motion between frames with sufficient accuracy are typically very computationally intensive. In modern video codec schemes, a frame can be segmented into basic coding blocks that can be subdivided into blocks of variable sizes to accommodate different motions within a frame. For example, a basic coding block for encoding using the H.264 codec is referred to as a macroblock and has a size up to 16×16 samples (or pixels). A basic coding block for encoding using the H.265 codec is referred to as a coding tree unit (CTU) and has a size up to 64×64 samples. Traditionally, integer motion estimation (also referred to as pixel motion estimation) is carried out in parallel for each coding block size, which leads to highly redundant computations that consume large amounts of computational resources. FIGS. 1-8 introduce techniques for implementing a hierarchical and partitional motion estimation search (IMES) architecture using a search engine that is configurable based on the video sequence content. The hierarchical and partitional IMES (also referred to as hierarchical and partitional motion estimation) architecture with the configurable search engine described herein improves the efficiency of the motion estimation search process by setting relevant search parameters based on the video content to be encoded and is fully adaptable for different codec schemes.

In some aspects, the hierarchical and partitional IMES architecture with the configurable search engine performs increasingly higher resolution motion estimation search iterations for each partition or coding block in a video frame of a video sequence. Each iteration of the motion estimation search is based on the results of the previous iteration and on the content of the video sequence, wherein the content is indicative of motion features that are tracked across the video sequence. Each iteration of the motion estimation search thus searches, in increasingly higher resolution, for matching pixel blocks for frames in a video sequence, eventually culminating in a full pixel level motion estimation search to determine the integer (or pixel level) motion vectors for video encoding purposes. In some embodiments, the hierarchical and partitional IMES architecture utilizes a configurable search engine based on search parameters that are identified from the content of the video sequence. Examples of such identified search parameters include a search range (also referred to as search area) or a number of search centers that indicate a number of initial search positions in the search range. Information describing the content of the video sequence, in some embodiments, is compiled in a histogram (or another type of compiled distribution of data) and describes one or more motion features tracked across the plurality of frames in the video sequence. The motion features indicate the degree and complexity of motion (together referred to as a range of motion) in the video sequence, and include, for example, motion vector magnitudes or a quantity of motion vectors per video frame. In this manner, the techniques provided herein recognize that typical sequences of video frames range from having content characterized by slow and simple motion (e.g., slowly panning across an open landscape) to content characterized by fast and complex motion (e.g., a close-up view focused on a battle scene) and exploit this information to configure the motion estimation searches accordingly.

To further demonstrate by way of example, the hierarchical and partitional IMES architecture with the configurable search engine uses larger sized coding blocks, smaller search ranges, and fewer search centers for video sequences with the slow and simple motion type and uses smaller sized coding blocks, larger search ranges, and more search centers for video sequences with the fast and complex motion type. By utilizing the content of the video sequence to set the search parameters, the hierarchical and partitional IMES architecture with the configurable search engine provides a more relevant sized search area and/or number of search centers. This in turn increases the quality of the motion estimation search while utilizing the computational resources more prudently to avoid the redundant computations of conventional techniques.

To illustrate, the hierarchical and partitional IMES architecture with the configurable search engine includes an initial decimated search (also referred to as a downsampled search) to search for matching downsampled pixel blocks over a larger area of a current frame and reference frame and using the results from this initial decimated search to guide lower level (i.e., higher resolution) decimated searches or a full pixel search (also referred to as full search). To achieve high search precision, in some embodiments, multiple search centers are used at each coding block level or search block of the decimated and/or full searches. Additionally, in some embodiments, a two-dimensional sum of absolute differences (SAD) array is utilized to enable a bottom-up accumulation strategy to calculate the motion costs for the different search blocks in the hierarchical and partitional IMES architecture. This technique speeds up the motion estimation calculations since fewer cycles are needed to achieve the same, or better, level of performance. Furthermore, in some embodiments, the number of search centers and the size of the search ranges or the coding block levels are based on the content of the video sequence, where the content is indicative of a complexity or degree of motion in the video sequence. By utilizing the content of the video sequence to set the search parameters in the hierarchical and partitional IMES architecture, the techniques described herein provide a better quality motion estimation search that covers a more relevant search range to improve the efficiency of determining motion vectors in the video encoding process.

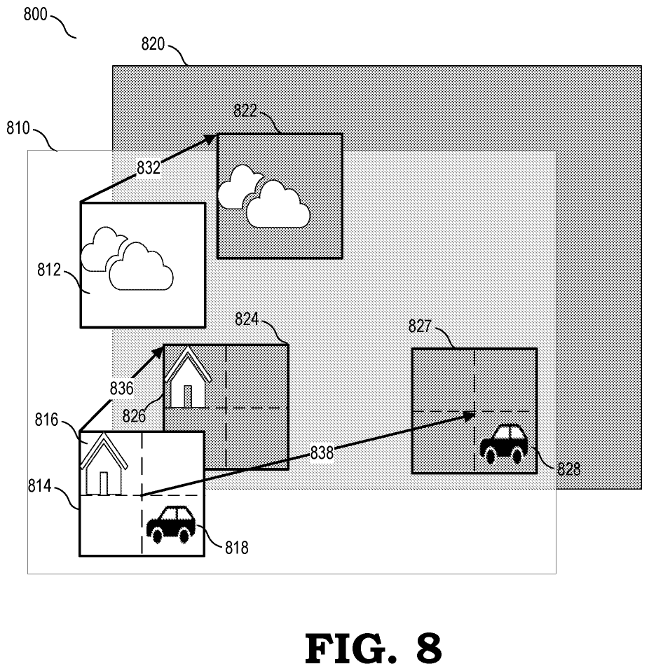

FIG. 1 shows a diagram of a video system 100 in accordance with various embodiments. The video system 100 includes a transmitting device 102 and a receiving device 120. The transmitting device 102 generates encoded video data, such as video data corresponding to the frames illustrated in FIG. 8, and, in some embodiments, is referred to as a video encoding apparatus. The receiving device 120 decodes the coded video data generated by the transmitting device 102, and, in some embodiments, is referred to as a video decoding apparatus.

Examples of the transmitting device 102 and the receiving device 120 include one or more of a desktop computer, a mobile computing apparatus, a laptop computer, a tablet computer, a handheld mobile phone, a television, a camera, a display apparatus, a digital media player, a video game console, an in-vehicle computer, a wireless communications device, an artificial intelligence (AI) device, a virtual reality/hybrid reality/augmented reality device, an autonomous driving system, or a video stream transmission device such as a content service server or a content delivery server.

In some embodiments, the transmitting device 102 and the receiving device 120 each include one or more processors and a memory coupled to the one or more processors. For example, for transmitting device 102, memory 114 is communicatively coupled with one or more of the other illustrated components in the transmitting device 102, and for receiving device 120, memory 132 is communicatively coupled with one or more of the other illustrated components in the receiving device 120. In some embodiments, each of memory 114, 132 includes a random access memory (RAM), a read-only memory (ROM), an electrically erasable programmable read only memory (EEPROM), a flash memory, or any other storage medium that can be configured to store program code in the form of instructions or a data structure to be accessed by a computer.

The transmitting device 102 and the receiving device 120 are connected by a communication link 140 through which the receiving device 120 receives the encoded video data from the transmitting device 102. In some embodiments, the communication link 140 includes one or more communication media that enable the transmitting device 102 to directly transmit the encoded video data to the receiving device 120 in (near) real-time. For example, the transmitting device 102 modulates video data based on a communications standard (e.g., a wireless communications protocol) and transmits modulated video data to the receiving device 120. In some embodiments, the one or more communications media include a wireless or wired communications medium, such as a radio frequency (RF) spectrum or a physical transmission line.

In some embodiments, the transmitting device 102 includes an image source 104, an image preprocessor 106, an encoder 108 (also referred to as a video encoder) with a motion estimator 110 (also referred to motion estimation circuitry), a transmitter 112, and a memory 114. In some embodiments, each of these components in transmitting device 102 are implemented as hardware, software, or a combination thereof.

In some embodiments, the image source 104 includes an image capturing device such as a camera configured to capture a picture or video. In some embodiments, the image source 104 includes a memory configured to store a picture or a video. The image source 104 may further include any type of (internal or external) interface through which a previously captured or generated picture is stored and/or a picture is obtained or received. In some embodiments, an image stored in or captured by the image source 104 is described as a two-dimensional array or a matrix of pixels corresponding to a frame in a video sequence such as the frames illustrated in FIG. 8. In some embodiments, a sequence of frames in the horizontal and vertical directions (or axes) of the two-dimensional array defines a size and/or resolution of the picture. In some embodiments, three color components represent the colors in a frame. For example, in a red-blue-green (RBG) form or color space, the frame includes a red array, a green array, and a blue array. In some embodiments, each pixel is represented in a luminance and chrominance format. For example, a frame in a YUV format includes a luminance component indicated by Y and two chrominance components indicated by U (blue projection) and V (red projection). Accordingly, the frame in the YUV format includes a luminance sample array of luminance sample values (Y) and two chrominance sample arrays of chrominance values (U and V). A frame in an RGB format may be transformed or converted into a YUV format and vice versa. In some embodiments, a frame transmitted by the image source 104 to the image preprocessor 106 is referred to as raw image data.

The image preprocessor 106 is configured to receive the raw image data and perform preprocessing on the raw image data to generate preprocessed image data. For example, the preprocessing performed by the image preprocessor 106 includes trimming, color format conversion (e.g., from an RGB format to a YUV format), color correction, or de-noising. The encoder 108 is configured to receive the preprocessed image data and encode the preprocessed image data to generate an encoded video stream. For example, the encoded video stream includes one or more motion vectors determined by the hierarchical and partitional IMES architecture with the configurable search engine described herein. In some embodiments, the encoder 108 includes a motion estimator 110 to implement the hierarchical and partitional IMES architecture with the configurable search engine as described herein. Accordingly, the motion estimator 110 includes hardware including one or more processors and/or software to execute these methods, e.g., to execute motion estimation searches to determine motion vectors for one or more blocks of pixels in a frame of a video sequence. In some embodiments, the transmitter 112 receives the encoded video stream and transmits it to the receiving device 120 through the communication link 140. The transmitter 112, for example, is configured to encapsulate the encoded video stream into an appropriate format (e.g., a data packet) for transmission over the communication link 140.

The receiving device 120 includes a receiver 122, a decoder 124, an image postprocessor 128, a display 130, and a memory 132. Generally, the components of the receiving device 120 are configured to reverse the image processing performed by the transmitting device to display the image (or video frames) from the image source 104 on the display 130.

The receiver 122 is configured to receive the encapsulated encoded video stream from the transmitting device 102. In some embodiments, the receiver 122 is configured to decapsulate the data packets transmitted by the transmitter 112 to obtain the encoded video stream. The decoder 124 is configured to receive the encoded video stream and provide a decoded video stream. In some embodiments, the decoder 124 is configured to receive the motion vectors generated by the motion estimator 110 and perform a video decoding method utilizing these motion vectors. For example, this may include generating a decoded video steam with a plurality of video frames based on a reference frame and a corresponding set of motion vectors. The image postprocessor 128 is configured to perform postprocessing on the decoded video stream to obtain a postprocessed video stream. In some embodiments, the postprocessing performed by the image postprocessor 128 includes color format conversion (e.g., from a YUV format to an RGB format), color correction, trimming, re-sampling, or any other image postprocessing. In some embodiments, the image postprocessor 128 is further configured to transmit the postprocessed video stream to the display 130. The display 130 is configured to receive the postprocessed video stream for displaying the video to a viewer. The display 130 may be or include any type of display for presenting a reconstructed video. For example, in some embodiments, the display 130 is an integrated or external display or monitor. In some embodiments the display 130 is one or more of a liquid crystal display (LCD), an organic light emitting diode (OLED) display, a micro light emitting diode (LED) display, a liquid crystal on silicon (LCoS) display, a digital light processor (DLP), a plasma display, a projector, or other type of display.

While shown as separate in FIG. 1, in some embodiments, the transmitting device 102 and the receiving device 120 are integrated into a single device. In other words, the integrated device includes functions of both the transmitting device 102 and the receiving device 120. In some embodiments, the transmitting device 102 and the receiving device 120 in such an integrated device are implemented by using same hardware and/or software, separate hardware and/or software, or any combination thereof.

In some embodiments, the encoder 108 and the decoder 124 are implemented as any one of various suitable circuits, e.g., one or more microprocessors, digital signal processors (DSP), application-specific integrated circuits (ASIC), field-programmable gate arrays (FPGA), discrete logic, hardware, or any combination thereof. In some embodiments, the hierarchical and partitional IMES architecture with the configurable search engine described herein is at least partially implemented by software.

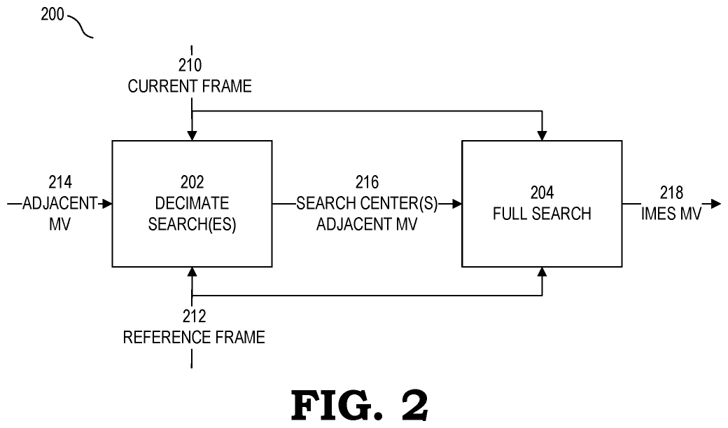

FIG. 2 shows a diagram 200 illustrating a hierarchical aspect of the hierarchical and partitional IMES architecture in accordance with various embodiments. In some embodiments, a motion estimation unit of a video encoder, such as motion estimator 110 in encoder 108 in FIG. 1, implements the hierarchical and partitional IMES architecture shown in diagram 200. In some embodiments, the hierarchical and partitional IMES architecture includes one or more decimated searches in decimated search block 202 followed by a full search 204 (also referred to as a full pixel search), where each of the decimated searches in decimated search block 202 uses a down-sampled frame information to conduct a motion estimation search within a frame of a video sequence. The search results of the decimated search are used as search centers (also referred to as initial search points in frame) for the next decimated search (if applicable) or for the full search 204. In this manner, the decimated searches in decimated search block 202 provide one or more search center candidates around which the full search 204 conducts a refined search to selects the sample with the smallest rate distortion optimization (RDO) to determine the hierarchical and partitional IMES motion vector (MV) 218. In some embodiments, each search of the one or more decimated searches and the full search correspond to one search level of a plurality of search levels, where the full search is the final search level.

The hierarchical and partitional IMES architecture described herein provides a motion estimation scheme to search for and select the most accurate motion vectors based on rate distortion optimization (RDO), which is an optimization between rate and distortion. In some embodiments, the rate is estimated with motion cost, which is calculated based on adjacent motion vector(s). In some embodiments, the distortion is evaluated based on a metric such as Sum of Absolute Difference (SAD), Hadamard Transformed SAD (SATD), Sum of Square Error (SSE), or the like. In some embodiments, for example, the hierarchical and partitional IMES architecture uses a SATD metric design.

To illustrate, in some embodiments, the decimated search block 202 receives a current frame 210 (e.g., corresponding to current frame 810 in FIG. 8) and a reference frame 212 (e.g., corresponding to previous frame 820 in FIG. 8). For example, these frames are retrieved from a buffer or other memory component after undergoing image preprocessing (as discussed in FIG. 1). In some embodiments, the decimated search block 202 receives an adjacent motion vector (Adjacent MV) 214 information to aid in the hierarchical and partitional IMES searches. In some embodiments, the Adjacent MV 214 is derived from an Adjacent MV block (not shown) that computes an initial search center estimation for the decimated search and provides a predicted motion vector (PMV) for motion cost calculation. Based on these inputs, the decimated search block 202 conducts a downsampled motion estimation search. For example, the current frame 210 is downsampled and a corresponding down-sampled reference frame is read back from a buffer or memory. Then, computations calculating differences indicative of the transformation of pixel blocks in the downsampled current frame with respect to the downsampled reference frame are performed. This can include, for example, computing a sum of absolute differences (SADs) or SATDs between blocks of pixels in the downsampled current frame and blocks of pixels in the downsampled reference frame for each search per cycle. The SAD or SATD, along with the motion cost based on the one or more adjacent motion vector(s), is forwarded to a RDO calculation and partition processing block, which measures the amount of distortion (i.e., loss of video quality) against the bit cost to encode the video (i.e., the rate) for each candidate block. After determining the best RDO results in the initial decimated search in decimated search block 202, the results are fed to the next level decimated search in decimated search block 202 or to the full search 204 to set the search centers for those respective searches.

In some embodiments, the full search 204 performs similar functions as the decimated search(es) in decimated search block 202, albeit at a full-pixel level, and uses the output 216 from the decimated search(es) 202 to set its search center(s). The full search 204 is performed using the current frame 210 and the reference frame 212. That is, in some embodiments, the frame data for the current frame 210 and the reference frame 212 is not downsampled for the full search 204 so that the full search 204 can be performed at the pixel-level. The results of full search 204 with the smallest rate distortion optimization (RDO) values are used compute the hierarchical and partitional IMES motion MVs 218, or full-pixel MVs, that are used in the video encoding process.

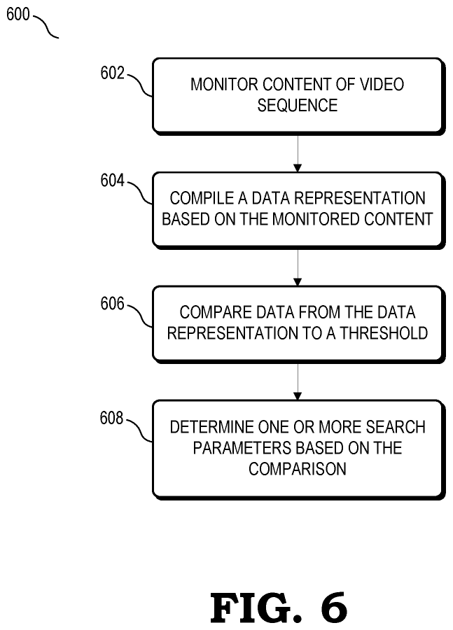

The hierarchical aspect of the hierarchical and partitional IMES architecture illustrated in diagram 200 provides numerous advantages. First, although highly accurate, a comprehensive full pixel search for entire video frames requires utilizing huge amounts of computational resources. By implementing one or more decimated searches as described herein, the hierarchical and partitional IMES architecture greatly reduces the computational load since the results of the coarser searches set the search centers to focus the more refined full search. Furthermore, at each decimated search step, the search results are generated for each coding block level. This provides accurate search guidance for each coding block in the next search whether that be a lower order decimated search or the full search. In some embodiments, the search centers are also based on the monitored content of the video sequence (e.g., as described in FIG. 6). Accordingly, by setting the search parameters based on the video content and based on the previous search, the hierarchical and partitional IMES architecture with the configurable search engine provides highly accurate MVs while utilizing fewer computational resources than a comprehensive full pixel search.

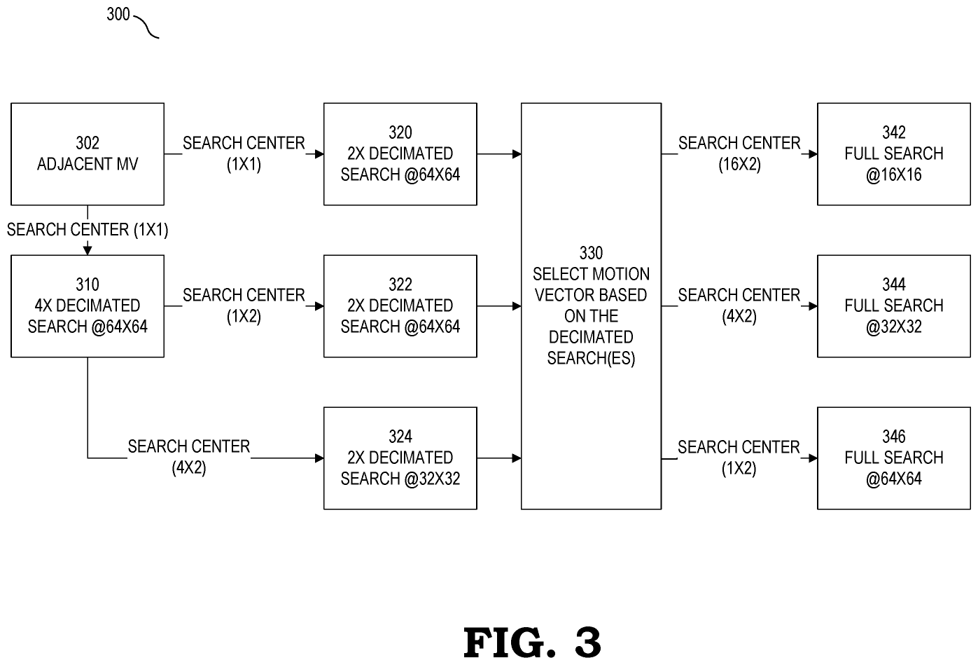

FIG. 3 shows a search flow diagram 300 for a hierarchical and partitional IMES architecture in accordance with various embodiments. The search flow diagram 300 is illustrated and described for encoding using the H.265 codec, but it is appreciated that the concepts described herein are similarly envisioned for encoding using other codec schemes, e.g., H.264 or other codec schemes. Accordingly, depending on the codec scheme, the number of decimated searches, the size of the search ranges, the choice of coding blocks, or the number of search centers can be adjusted accordingly.

As shown in search flow diagram 300, the setting of the search centers for each subsequent search is, at least in part, based on results from the previous search. In some embodiments, the determination of the search centers and the search flow are additionally based on the content of a video sequence. The format (M×N) of search center information between each search block indicates the total number of search centers, where M is the number of the search blocks, and N is the number of search centers per block.

First, the Adjacent MV 302 is determined. In some embodiments, the adjacent MV(s) are derived from the neighboring blocks of the block being searched, e.g., the top and left neighboring blocks. Then, the initial decimated search is carried out. In the example shown in search flow diagram 300 for H.265, the initial decimated search is selected from one of two options: a four-times (4×) Decimated search at 64×64 block 310 or a two-times (2×) Decimated search at 64×64 block 320. In some embodiments, the initial decimated search is selected based on the content of the video sequence. For example, in some embodiments, for a monitored video sequence with more complex motions, the 4× Decimated search at 64×64 block 310 is carried out as the initial decimated search to provide coarse search results to set the search centers for the subsequent 2× Decimated Search. FIG. 5 provides example diagrams illustrating downsampled versions (e.g., 4× and 2×) of pixel blocks.

Referring back to FIG. 3, if the initial decimated search is the 4× Decimated search at 64×64 block 310, the adjacent MV 302 provides the search parameters (1×1), which in this case indicates one search block and one search center. In the case the initial decimated search is the 2× decimated search at 64×64 block 320, similar search parameters (1×1) are provided. In some embodiments, the 2× Decimated search at 64×64 block 320 is selected as the initial decimated search, for example, based on the monitored content of the video sequence indicating a lower motion complexity across the frames (e.g., a motion vector quantity or a motion vector magnitude per frame being below a motion vector quantity threshold or a motion vector magnitude threshold, respectively).

In the scenario where the initial decimated search is a 4× Decimated search at 64×64 block 310, the next search is a 2× Decimated search at 64×64 block 322 or a 2× Decimated search at 32×32 block 324. In some embodiments, the selection between the 2× Decimated search at 64×64 block 322 or the 2× Decimated search at 32×32 block 324 is based on the monitored content of the video sequence. For example, in some embodiments, for a monitored video sequence with a higher degree of complexity, the 2× Decimated search at 32×32 block 324 is selected. In some embodiments, the higher degree of motion complexity is determined based on a comparison to a motion complexity threshold, such as a motion vector magnitude threshold or a motion vector quantity threshold. For example, the determination of a higher degree of motion complexity is made when the motion vector magnitude is above the motion vector magnitude threshold or a quantity of motion vectors per frame is above a motion vector quantity threshold. For the 2× Decimated search at 64×64 block 322, the search parameters (1×2) correspond to one search block (with a size of 64×64 block) and two search centers. For the 2× decimated search at 32×32 block 324, the search parameters (4×2) correspond to four search blocks (at 32×32 block) and two search centers per search block.

Based on the results from the 2× Decimated search at 64×64 320, the 2× Decimated search at 64×64 322, or the 2× Decimated search at 32×32 324, the motion vector with the minimum RDO cost (i.e., the best match between the current frame and the previous frame) is selected 330. This information sets the search centers for the full search (also referred to as full pixel search).

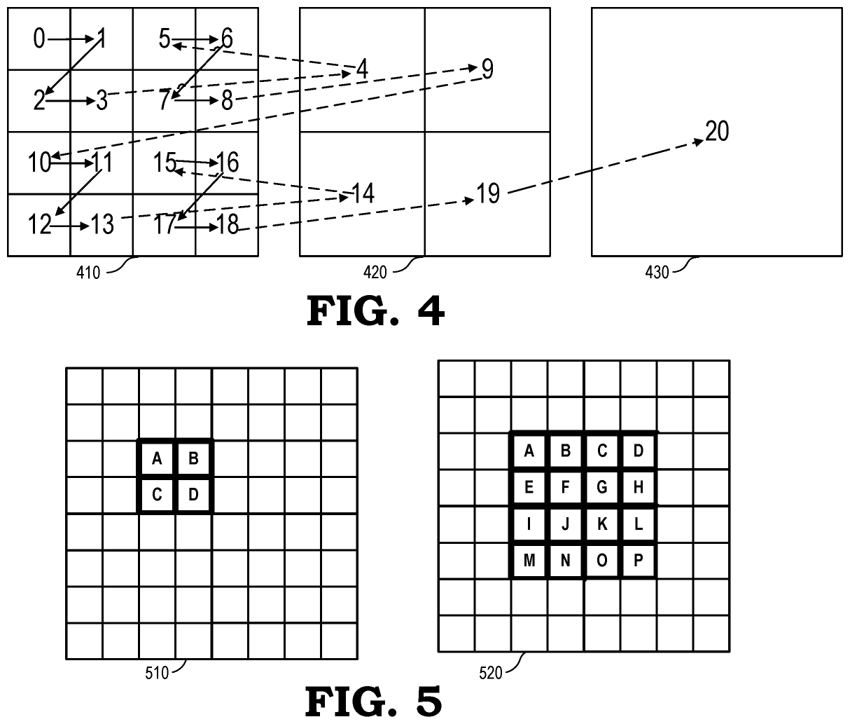

The full search is performed at three different coding block levels: a full search at 16×16 342, a full search at 32×32 344, and a full search at 64×64 346. The search parameters at each level (e.g., search center (16×2) for the full search at 16×16 342, search center (4×2) at full search at 32×32 344, and search center (1×2) at full search at 64×64 346) is guided by the results from the motion vectors selected at 330 resulting from the 2× Decimated searches. In some embodiments, the full search is performed in z-scan order as shown in FIG. 4. In FIG. 4, block 410 shows sixteen 16×16 search blocks corresponding to the full search at 16×16 342, block 420 shows four 32×32 search blocks corresponding to the full search at 32×32 344, and block 430 shows a single 64×64 search block corresponding to the full search at 64×64 346. The numbers in each of the blocks shown in FIG. 4 show the scan search order starting at “0” for the upper-left block in the 16×16 block 410 to “20” for the 64×64 block 430. For the 16×16 block 410, the search is conducted starting at two different search centers per 16×16 block, so a total of 32 16×16 block searches are conducted. Similarly, the search is conducted starting at two different search centers for the 32×32 block 420 and the 64×64 block 430. Referring back to FIG. 3, after the performance of the full searches at each of 342, 344, and 346, the RDO is computed for the overlapping areas (e.g., referring to FIG. 4, an overlapping area corresponds to blocks 0-3 in the 16×16 block 410 and block 4 in the 32×32 block 420). Then, the motion vector is selected based on the blocks with the lowest RDO value.

It is appreciated that the search parameters, including the search center information expressed as “Search Center (MxN)” in FIG. 3, are listed as examples for purposes this explanation. Therefore, in some embodiments, the parameter M (indicating the number of the coding blocks, e.g., the CU in H.265) and the parameter N (indicating the number of search centers per block M) are adapted based on the content of the monitored video sequence. For example, the values for M and/or N are higher for a monitored video sequence with more complex motion between frames (e.g., a close-up view focused on a battle scene) and lower for a monitored video sequence with less complex motion between frames (e.g., slowly panning across an open landscape).

FIG. 5 shows examples of a block being downsampled for the 2× decimated searches and the 4× decimated search, such as those discussed with respect to FIG. 3, in accordance with various embodiments. Block 510 shows an example of a 2-times (2×) decimated search subsample where the average of four adjacent pixels A, B, C, and D is taken as a downsample. Block 520 shows an example of a 4-times (4×) decimated search subsample where the average of sixteen adjacent pixels (A to P) is taken as a downsample. Downsampling the pixel data to conduct the decimated searches significantly reduces the computational load and provides accurate search center information for the next search (e.g., the full pixel search). It is appreciated that blocks 510 and 520 illustrate examples of a 2× decimated search and a 4× decimated search, respectively, and other variants of decimation or downsampling pixels are similarly envisioned and included within the context of this disclosure.

FIG. 6 shows a flowchart 600 illustrating a method for determining one or more search parameters for the search flow in a hierarchical and partitional IMES architecture, e.g., corresponding to FIG. 3, in accordance with various embodiments. In some embodiments, the method shown described in flowchart 600 is executed by an encoder such as the encoder 108 in transmitting device 102 in FIG. 1.

At 602, the method includes monitoring the content of the video sequence including a plurality of frames. In some embodiments, this includes tracking one or more motion features across a plurality of the frames in a video sequence. In some embodiments, the motion features include a magnitude of the motion vectors in each of the plurality of frames or a quantity of motion vectors in each of the plurality of frames. In some embodiments, the one or more motion features indicate the complexity and/or magnitude of motion in the video sequence.

At 604, the method includes compiling a data representation based on the monitored content. In some embodiments, the monitored content is stored in a memory as a compiled distribution of data, such as a histogram, representative of the one or more motion features. The compiled data representation includes information indicative of a complexity of motion for the plurality of frames in the video sequence. For example, the compiled data includes information about a motion vector magnitude indicative of a magnitude of motion for one or more blocks in a first frame of the plurality of frames relative to a corresponding one or more pixel blocks in a second frame of the plurality of frames or a motion complexity value indicative of a quantity of motion vectors and/or the directions of the motion vectors associated with a first frame of the plurality of frames relative to a second frame of the plurality of frames. In some embodiments, the plurality of frames corresponds to a particular number of frames preceding the current frame in the video sequence to represent a recent history of the video sequence. For example, the plurality of frames represents the most recent 0.1 seconds to 5 seconds of the video sequence.

At 606, the method includes comparing the data from the compiled data representation to a motion complexity threshold. For example, if the compiled data representation includes values indicating the quantity (or count) of motion vectors and/or the magnitude of the motion vectors for a plurality of frames in the video sequence, one or both of these values is compared to a corresponding motion complexity threshold. If values of the compiled data representation exceed the corresponding motion complexity threshold, then a first set of search parameters is used. If the values of the compiled data representation do not exceed corresponding motion complexity threshold, then a second set of search parameters are used. In some embodiments, the first set of search parameters are indicative of a video sequence with higher degrees of motion and/or more complex motion, and the second set of search parameters are indicative of a video sequence with simpler motions.

At 608, the method includes determining one or more search parameters based on the comparison. The determined one or more search parameters are then used to set the hierarchical and partitional IMES search flow or used to determine the number of search centers or search range (i.e., search area) to use in the decimated search(es) or in the full search. For example, referring to FIG. 3, determining the one or more search parameters includes one or more: determining whether to conduct the initial decimated search at a 4× decimated search block 310 or a 2× decimated search block 320, determining the search range for a subsequent 2× decimated search (e.g., selecting between the 2× decimated search at 64×64 322 or the 2× decimated search 32×32 324), determining the number of search centers (i.e., N), determining a search partition size (such as 64×64, 32×32, 16×16, or the like), and/or determining a search range (i.e., the surrounding area of the search center).

Accordingly, by performing the method illustrated by flowchart 600, a video encoder, such as encoder 108 in FIG. 1, is configured to adaptively select the search parameters for the hierarchical and patronal IMES architecture, such as one described in FIG. 3, to determine motion vectors in the video encoding process.

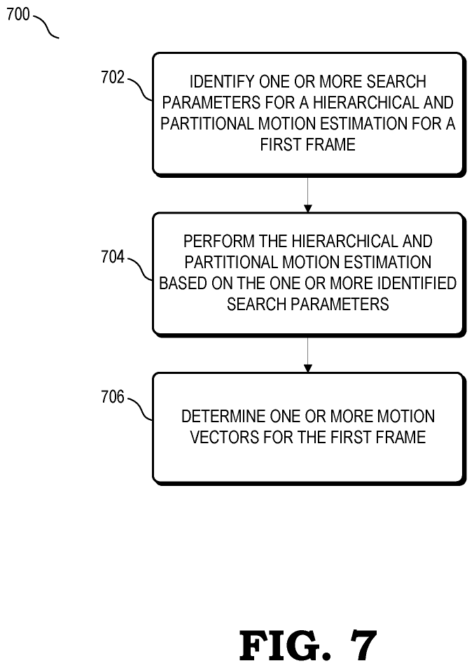

FIG. 7 is a flowchart 700 illustrating a hierarchical and partitional IMES method for determining motion vectors to use in a video encoding process in accordance with various embodiments. In some embodiments, the method shown described in flowchart 700 is executed by an encoder such as encoder 108 in transmitting device 102 in FIG. 1.

At 702, the method includes identifying one or more search parameters for a hierarchical and partitional motion estimation for the first frame. In some embodiments, the identification of the one or more search parameters is based on the monitoring of a video sequence method shown in FIG. 6. At 704, the method includes performing the hierarchical motion estimation based on the one or more identified search parameters. In some embodiments, the hierarchical and partitional motion estimation corresponds techniques described with respect to the search flow diagram shown in FIG. 3. At 706, the method includes determining, in response to performing the hierarchical and partitional motion estimation, a motion vector associated with a pixel block in the first frame relative to a reference pixel block in a second frame to use in the video encoding process. Examples of such motion vectors are illustrated in FIG. 8.

FIG. 8 shows a diagram 800 illustrating motion vectors for different coding block sizes in accordance with various embodiments. Diagram 800 shows a current frame 810 and a previous frame 820 (also referred to as reference frame) that are captured sequentially in a video sequence. For purposes of clarity and this explanation, the current frame 810 is illustrated as being juxtaposed over the previous frame 820.

The current frame 810 includes a first block 812 and a second block 814. For example, for encoding using the H.264 codec, the first block 812 and the second block 814 correspond to a macroblock with a size of 16×16 pixels. In another example, for encoding using the H.265 codec, the first block 812 and the second block 814 correspond to a CTU with a size up to 64×64 pixels. The second block 814 is partitioned into four smaller blocks (e.g., 32×32 pixels) including partitioned block 816 and partitioned block 818. The first block 812 includes pixels illustrating an image of a cloud, the partitioned block 816 includes pixels illustrating an image of a house, and the partitioned block 818 includes pixels illustrating an image of a vehicle.

The previous frame 820 includes a first block 822 and a second block 824. The second block 824 is partitioned into four smaller blocks including partitioned block 826. Additionally, the previous frame 820 includes a third block 827 that is partitioned into four smaller blocks including partitioned block 828. The first block 822 of the previous frame 820 includes pixels illustrating an image of the cloud and, in some embodiments, corresponds to the cloud depicted in the first block 812 in the current frame 810. In some embodiments, assuming the cloud has not changed color or shape, a single motion vector 832 is sufficient to represent the motion of the pixels in first block 812 for the current frame 810 relative to the corresponding first block 822 with the cloud in the previous frame 820. On the other hand, a single motion vector may not be suitable to describe the motion of the second block 814 in the current frame 810 relative to the second block 824 in the previous frame 820 since the pixels illustrating the house and the pixels illustrating the vehicle have undergone different motion transformations. To account for this, the second blocks 814, 824 in the current frame 810 and the previous frame 820, respectively, are divided into smaller partitions, and a separate motion search to determine the motion vector for each partition is carried out. A third block 827 in the previous frame 820 is identified and utilized to determine the motion vector of the pixels illustrating the vehicle. In some embodiments, the third block 827 in the previous frame 820 is divided into smaller partitions so that a single partition includes the pixels illustrating the image of the vehicle, i.e., partitioned block 828.

Accordingly, after performing the motion estimation searches in accordance with various embodiments described herein, an encoder with a motion estimation unit as described herein (e.g., encoder 108 with motion estimator 110) determines the motion vector 836 to describe the motion of the pixels illustrating the image of the house between partitioned block 826 in the previous frame 820 and partitioned block 816 of the current frame 810, and determines motion vector 838 to describe the motion of the pixels illustrating the image of the vehicle between partitioned block 828 of the previous frame and partitioned block 818 of the current frame 810.

In some embodiments, the hierarchical and partitional IMES architecture with the configurable search engine described in FIGS. 1-8 determines the motion vectors 832, 836, and 838 by utilizing one or more decimated searches and a full search with search parameters that are, at least in part, based on monitoring a content of a video sequence including the current frame 810 and the previous frame 820.

In some embodiments, the apparatus and techniques described above are implemented in a system including one or more integrated circuit (IC) devices (also referred to as integrated circuit packages or microchips), such as the encoder 108 and motion estimator 110 described above with reference to FIG. 1. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium (also referred to as a non-transitory computer-readable medium), or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory) or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
identifying, based on a plurality of frames, one or more search parameters for a hierarchical and partitional motion estimation for a first frame relative to a second frame of the plurality of frames, wherein the one or more search parameters are based on a content of the plurality of frames;
performing the hierarchical and partitional motion estimation based on the one or more identified search parameters; and
determining, in response to performing the hierarchical and partitional motion estimation, a motion vector.

2. The method of claim 1, further comprising:
compiling a distribution of data from the plurality of frames by tracking one or more motion features across the plurality of frames indicative of the content; and
identifying the one or more search parameters based on the compiled distribution of data.

3. The method of claim 2, wherein the identifying of the one or more search parameters is based on a value associated with the distribution of data exceeding a threshold.

4. The method of claim 2, wherein the one or more motion features are associated with at least one of: a motion vector magnitude indicative of a magnitude of motion in the plurality of frames, or a motion complexity value indicative of at least one of a quantity of motion vectors or quantity of directions of motion vectors in the plurality of frames.

5. The method of claim 4, wherein the one or more search parameters comprises a plurality of search levels in the hierarchical and partitional motion estimation, a search range to use in one or more of the search levels of the plurality of search levels, or a number of search centers to use in one or more of the search levels of the plurality of search levels.

6. The method of claim 5, further comprising using a smaller search range for one or more search levels of the plurality of search levels based on:
the motion vector magnitude being above a motion vector magnitude threshold compared to if the motion vector magnitude was below the motion vector magnitude threshold; or
the motion complexity value being above a motion complexity threshold compared to if the motion complexity value was below the motion complexity threshold.

7. The method of claim 5, further comprising using a higher number of search centers for one or more search levels of the plurality of search levels based on:
the motion vector magnitude being above a motion vector magnitude threshold compared to if the motion vector magnitude was below the motion vector magnitude threshold; or
the motion complexity value being above a motion complexity threshold compared to if the motion complexity value was below the motion complexity threshold.

8. The method of claim 1, wherein the hierarchical and partitional motion estimation comprises a plurality of search levels to determine a pixel block in the first frame relative to a reference pixel block in the second frame, wherein the plurality of search levels comprises one or more decimated searches followed by a full search.

9. The method of claim 8, wherein each of the one or more decimated searches comprises searching downsampled versions of the first frame and the second frame to provide one or more search centers for a subsequent decimated search or for the full search.

10. The method of claim 9, wherein each subsequent decimated search is at a higher resolution than a previous decimated search.

11. The method of claim 9, wherein the one or more decimated searches comprise a decimated search based on downsampling a first plurality of adjacent pixels in the first frame.

12. The method of claim 9, wherein the one or more decimated searches comprises:
a first decimated search based on a first set of samples comprising a first plurality of adjacent pixels in the first frame and a corresponding first set of samples in the second frame; and
a second decimated search based on a second set of samples comprising a second plurality of adjacent pixels in the first frame and a corresponding second set of samples in the second frame, wherein the first plurality is a multiple of the second plurality.

13. The method of claim 8, wherein each search in the plurality of search levels comprises searching a search range in the first frame to identify a matching block of pixels corresponding to a block of pixels in the second frame.

14. The method of claim 13, wherein the matching block of pixels of a final search level in the plurality of search levels is used to determine the motion vector.

15. A device comprising:
motion estimation circuitry configured to:
identify, based on a plurality of frames, one or more search parameters to utilize in a hierarchical and partitional motion estimation for a first frame relative to a second frame in the plurality of frames, wherein the one or more search parameters are based on a content of the plurality of frames;
perform the hierarchical and partitional motion estimation based on the one or more identified search parameters; and
determine, in response to performing the hierarchical and partitional motion estimation, a motion vector.

16. The device of claim 15, further comprising:
a memory; and
the motion estimation circuitry configured to:
compile a distribution of data from the plurality of frames by tracking one or more motion features across the plurality of frames indicative of the content; and
identify the one or more search parameters based on the compiled distribution of data.

17. The device of claim 16, wherein the identifying of the one or more search parameters is based on a value associated with the distribution of data exceeding a threshold.

18. The device of claim 17, wherein the one or more search parameters comprises a plurality of search levels in the hierarchical and partitional motion estimation, a search range to use in one or more of the search levels of the plurality of search levels, or a number of search centers to use in one or more of the search levels of the plurality of search levels.

19. The device of claim 17, wherein the hierarchical and partitional motion estimation comprises a plurality of search levels to determine a pixel block in the first frame relative to a reference pixel block in the second frame, wherein the plurality of search levels comprises one or more decimated searches followed by a full search, wherein the full search comprises a pixel level search.

20. A non-transitory computer-readable medium storing instructions that, when executed, cause one or more processors to:
identify, based on a plurality of frames, one or more search parameters to utilize in a hierarchical and partitional motion estimation for a first frame relative to a second frame in the plurality of frames, wherein the one or more search parameters are based on a content of the plurality of frames;
perform the hierarchical and partitional motion estimation based on the one or more identified search parameters; and
determine, in response to performing the hierarchical and partitional motion estimation, a motion vector.
